(19) United States
(12) Patent Application Publication
(10) Pub. No.: US 2010/0081411 A1
(43) Pub. Date: Apr. 1, 2010

(54) Multifunctional telemetry alert safety system (MTASS)

(75) Inventor: John Mathew Montenero, Moraga, CA (US)

Correspondence Address: John Mathew Montenero, 2021 Ascot Drive, Unit #4, Moraga, CA, 94556, US

(73) Assignee: John Mathew Montenero, III, Moraga, CA (US)

(21) Appl. No.: 12/286,210

(22) Filed: Sep. 29, 2008

(51) Int. Cl. H04M 11/04

(52) U.S. Cl. 455/404.2

(57) ABSTRACT

A personnel accountability and situational awareness monitoring communications system for emergency personnel that comprises wireless network-adaptable monitoring devices, peripherals and base station console software for telemetry monitoring of real-time information at a plurality of personnel accountability and situational awareness parameters of critical data about the safety, health and whereabouts of first responders deployed in typically hazardous environments. Exterior incident command, including fire, rescue, safety and other emergency agencies achieve real-time command view and control over a variety of personnel accountability and safety parameters during emergency response activities of personnel wearing the system of the present invention portable device while operating within the wireless network of an emergency incident scene. Configured to be carried by emergency services personnel while deployed on scene, the portable device is a multi-functional sensing and communicating integration of accountability and situational awareness technologies consolidated into one portable, telemetry device. The portable device's multifunctional integrated technology includes the monitoring, telemetry and alert notification of accountability identification, location, assignment notification, vital signs, ambient vicinity temperature, SCBA status, combustible gas sensing, video streaming, “evacuation” recall signaling, signal tracking and multi-alarm signaling if the wearer has either low remaining air pressure/time, impending thermal breakthrough, low battery power, exceeds the safety threshold for safe heart rate or external body temperature readings, or becomes motionless for a predetermined time period.

### FIELD OF THE INVENTION

This invention relates to the improvement of application in first responder device technology of real-time accountability, situational awareness and telemetry transmitting of such information over an integrative mobile area network. The goal is for incident commands to better determine location and situation, as well as improving asset allocation of emergency personnel and equipment, such as firefighters, rescuers or hazardous materials cleanup specialists, at the site of an emergency incident.

### BACKGROUND OF THE INVENTION

The system of the present invention, referred to as the “Multifunctional Telemetry Alert Safety System” (MTASS), relates to a plurality of accountability and situational awareness monitoring and communications system for emergency first responders deployed in hazardous situations. Emergency safety devices of this kind are used for example by fire fighters, emergency search & rescuers or generally whenever a disaster incident transpires and first responders are deployed within and around the emergency incident scene.

After first responders arrive on scene and begin working in often chaotic emergency situations, the present locations and the pluralities of safety status of each first responder on scene, and incident commands ability to maximize mobility deployments of those assets at a moments notice and manage the safety of those assets, is difficult to determine, minute-by-minute. Incident command has historically been very limited to the plurality of real-time accountability and situational awareness information monitoring of deployed personnel. A serious problem which often arises is the inability of incident command to know enough about the “who, what, where and why” of each first responder operating in a hazardous area. First responder teams may be working on various perimeters of an enflamed or structurally compromised building, but hidden from line-of-sight by emergency equipment, by corners, by some other structure, by smoke, or by the local terrain. If first responders are working on a roof top, or inside a structure, or heavily forested area, or deep within a confined space environment, the ability of not only locating but also monitoring a plurality of personnel safety status is significantly challenge by line-of-sight degradation and lacking situational technology integration. Teams may be disbursed over a large wild land region for search & rescue or forest fire fighting. Methods for determining the present location while simultaneously monitoring a plurality of all first responders situations on scene of an emergency incident, second-by-second, no matter where the workers may be located, have been deficient or require being equipped with a plurality of costly and cumbersome non-integrated devices.

This leads to an extension of the accountability and situational awareness problem facing incident command and first responders in that emergency safety devices of this kind, whereas with other prior art generally consist of only one to five integrated technologies, as with SCBA air pressure reading, ambient temperature and PASS device technology. Some prior art consists of multiple pieces of equipment to comprise an entire system that includes some plurality of accountability and situational awareness, as for instance, SCBA integrated accountability and situational awareness equipment systems that are not always applicable or practical for use in every type of emergency incident response (e.g. wild-land firefighting, search & rescue). Where heavy and bulky SCBA integrated type accountability and situational awareness equipment systems of prior art are not applicable or practical, first responders and their command then concede the benefits of having those non-SCBA related technologies of accountability and situational awareness. Few prior art are ‘cable-less’ with enough plurality in wireless technology to overcome limits in freedom of movement, particularly in confined space areas, wild land or mountain rescue emergencies. Few if any prior art comprise wireless communication ability that will overcome short range communication alerts or the inability of incident command to monitor a plurality of personnel status in real-time, or the adaptability to integrate with other systems, as with prior art operating on other than non-mesh network, low-level radio transmission systems that are not integrative with other communication networks. Consequently, prior art for utilization by first responders operating in hazardous situations, as in collapsed structure, confined space, flood and mountain rescues or wild land fires, face device applicability limitations. First responders intensely focused on and moving through hazardous, chaotic conditions, while operating with hand tools and equipment, have limited time and ability to effectively wear, handle and monitor multiple accountability & safety devices or heavy and bulky SCBA-type integrated safety systems, which then become encumbering, obstructive and, as with cabled portable systems, may be entangled and limit range of motion.

Furthermore, prior art of proprietary design in accountability and situational awareness systems may lack economic practicality and system adaptability, particularly in integrated environments as within the “mutual aid” environment of between various emergency agencies integrating assets and resources within a given incident. Many situations resort to layers of manually integrated practices that significantly use up valuable time, increase margin for error and add cost to respond as events unfold during an emergency incident. Manual methods use some physical means of identifying whether a responder is present at the incident scene, and in some cases to identify where the responder is assigned during the emergency. Since these methods are manual, they do not provide a way to accurately account for all first responder personnel at an incident site, nor do they provide ways to track the actual location or status of first responder personnel around the incident site as the emergency unfolds. Therefore, it becomes crucial that as many as possible accountability and situational awareness technologies be integrated into one non-obstructing, unobtrusive, compact, rugged, multi-functional, wireless, cable-free, network adaptable, telemetry device that increases first responder real-time accountability, work efficiency and safety, while also providing reduced equipment maintenance/repair time and cost.

### SUMMARY OF THE INVENTION

Accordingly, the system of the present invention MTASS has been designed to overcome the above problems and to further meet other crucial needs of first responder agencies. The personnel accountability and situational awareness monitoring and communications abilities of the MTASS system's plurality of informational telemetry easily and rapidly provides exterior incident command with the real-time information they need to optimize safety and deployment management of personnel. While deployed personnel may be preoccupied with tasks during a chaotic emergency incident, any motionless, ambient temperature, gas, or biotelemetry alarms may go unnoticed for several valuable minutes before reacting. Incident command monitoring the plurality of accountability and situational awareness telemetry of deployed personnel from the MTASS mobile command base station software program can take a greater preventative position by immediate notice of current or impending dangers and ensure more timely action/reaction to such circumstances.

Between the system of the present invention MTASS's telemetry dashboard software and its provision for internet linkage, incident command can utilize the portable device's GPS tracking signal transmitting from each deployed portable device of the system of the present invention to track and visually map the locations of deployed personnel. This is particularly advantages for search/disaster rescue and wild-land firefighting. Incident command can also conduct local area radio frequency tracking of selected alarming portable devices for added support in personnel. accountability and location recovery. Incident command gains not only the insight of being able to monitor the health, environment and location of personnel, but also have command and control to recall selected individuals and whole teams from the system of the present invention's mobile command base station dashboard software program when danger appears eminent to deployed first responders via their monitoring portable devices.

For incident command within the “Mutual Aid” environment, the system of the present invention provides the commands of various emergency agencies with the ability to share, to interface and cross-communicate resources with one another, to share critical data, to create redundancies and greater operational networks for increased operational safety and effectiveness of incident response. The system of the present invention's network adaptability, its base station software design and its equipment and peripheral device interfacing flexibility allows for shared application across agencies.

Another aspect of the personnel accountability and situational awareness monitoring and communications system of the present invention is that the added plurality of having a greater variety of situational awareness technologies and accountability functions within a single portable device further ensures safety and operational effectiveness of first responders under chaotic conditions without compromise to the hazards of being encumbered with the obstructions, obtrusions and distractions of wearing, handling and monitoring multiple safety monitoring and communicating devices, cables and wires to perform their respective tasks.

Additionally, the system of the present invention conforms to most wireless networks and equipment, so public safety agencies need not encumber additional costs in having to purchase new or replace perfectly functional existing systems and equipment (i.e. wireless mesh networks, SCBAs, thermal imagers). Since the system of the present invention has an adaptable design to wireless network technologies and wireless peripheral equipment, its functionality is extended and augmented by its ability to interface with various wireless networks to assist in overcoming much of the non-line-of-site challenges facing technologies of this type. Wireless transmitter peripherals that are adaptable to existing agency equipment can be easily interfaced with the system of the present invention's modularly adaptable and programmable technology.

To fully achieve the optimization of incident command and control and in accordance with the purpose of the invention as embodied and broadly described herein, the personnel accountability and situational awareness monitoring and communications ability of the present invention MTASS also include mobile base console station software as a control system that operates over a wireless mobile area network (MANet). The MTASS software program is installed on mobile base station server consoles (e.g. ‘Toughbook’ computers) mounted in emergency services ground and aerial vehicles. The base station consoles and monitoring portable devices communicate telemetry by way of the system of the present invention's modular and programmable flexibility in platform configuration of either wireless 802.11 radio or 3G-cellular communications. This is established through both vehicle mounted and field deployable 802.11 network equipment, or through an existing cellular communications network. The choice of network platforms is dependant upon the geographical circumstances versus wireless network area infrastructure versus ad-hoc network preferences. Any plurality of emergency service vehicles equipped with a respective plurality of on-board computer & wireless network equipment comprise the means by which monitoring MTASS portable devices and their respective base station consoles running MTASS software programs communicate. Within the 802.11 radio communications environment, emergency services ground & aerial vehicle-mounted and field-deployable OEM wireless network technology functions as wireless ad-hoc network access points, bridges and repeaters to provide wireless ad-hoc or mobilized area network clusters that, when linked in overlapping clusters, ensures portable device connectivity and increased network area coverage, extending linkage to any present wide area or metro area mesh networks in place.

Each one of the plurality of on-board computer & wireless network systems is linked to remaining ones of the plurality of on-board computer & wireless network systems by way of a deployed wireless mobile area communication network (MANet).

Additional features and advantages of the invention will be set forth in part in the description which follows and in part will be apparent from the description, or may be learned by practice of the invention. The features and advantages of the invention may be realized and obtained by means of the instrumentalities and combinations particularly pointed out in the written description and claims hereof, as well as the appended drawings. The various functions provided by the system of the present invention's embodiment can be provided by any number or combination of components of the system of the present invention, and is not limited to being provided as described herein. Furthermore, the routing of information/data through the system of the present invention can be via any number or combination of components of the system of the present invention, and is not limited to the routings described herein. Likewise, the processing of information/data by the system of the present invention can be performed by any number or distributed among any combination of components of the system of the present invention, and is not limited to the processing locations described herein.

### DETAIL DESCRIPTION (SPECIFICATIONS)

The system of the present invention MTASS comprises a plurality of integrated accountability and situational awareness parameters that monitor and collect data from modularly interfacing technologies and associated wireless body area network (WBAN) or Bluetooth peripherals communicating by coded transmissions via 802.15.4 and processed through the system of the present invention's portable device's circuit board technology (see FIG. 1). Data collected from all sensing modules is processed to the portable device's motherboard interface's micro controller unit and programmable firmware chip set into secured PIN-coded telemetry processed out through the portable device's configurable wireless network interface card module (see FIGS. 2a,2b) for transmitting over a wireless Mobile Area Network (MANet) cluster and/or any 802.11 or 3G-cellular wireless dual-mesh Wide Area or Metro Area Network communications system (see FIG. 14a). The telemetry from monitoring MTASS portable devices is received to onsite MANet-deployed mobile command base station(s) (any emergency vehicle mounted computer server running the system of the present invention's software) and the public safety agency's Central Command running the software. The MTASS base station Personnel Accountability Management System (PAMS) software program translates PIN-coded telemetry transmissions received from monitoring MTASS portable devices. Then the software populates the PAMS “dashboards” and data logs the streaming telemetry, which enables incident command to remotely monitor real-time data and even recall recorded stored data transmitted from monitoring the system of the present invention's portable devices of first responders deployed within the wireless MANet of an incident scene (see FIGS. 12a,12b). In a mesh wide area or metropolitan area network environment, central command can monitor multiple incidences of multiple monitoring MTASS portable devices deployed within a given region (see FIGS. 1,14b).

The system of the present invention MTASS is multi-functionally integrated, wherein each portable device includes a main motherboard interface (See FIGS. 2a,7) to communicate with, process data from, and provide power to the four interfacing modular form factor technology modules and both a digital 7-segment 4-character alphanumeric LED display or may be in the form of a liquid crystal display (LCD) and a LED signal strength bar indicator lamp. The MTASS motherboard interface has an IC micro controller unit to process collected data for telemetry from interfacing technology modules. The motherboard Interface has a plug-in EEPROM firmware chip set that is re-programmable for customized device driver applications, as for example the type of wireless network interface card to be used. A dedicated firmware IC chip and small red switch button next to the LED display at the top of the MTASS portable device provides for single click programming of location assignment by codes that temporarily display during programming. The main interface motherboard Interface receives and provides power to integrated technologies from a prismatic Li-Ion rechargeable battery as the portable device's power source. The interface motherboard interface monitors the battery and provides a low battery alarm reading with 15 minutes operating time remaining, triggering an audible ‘tick’ sound and an alarm indicator warning that flashes “LOBA” on the portable device's LED display (See FIGS. 2b,5). With the MTASS portable device securely attached to a first responders' vehicle stored SCBAsystem, or stationed turnout coat, or stored in a vehicle mounted device rack, it is automatically activated (ON) once the charging plug is disconnected, placing the portable device in ‘sensing’ mode. When automatically activated or turned “On”, the operational signal is heard and a momentary visual signal of the module's internal LEDs flash in a sequence to indicate the unit is in the “Sensing” mode (ON). The MTASS portable device is deactivated (OFF) once the charger plug is reconnected to the MTASS portable device, thereby returning the unit to the ‘Storage/Charging’ position, or the wearer can press and hold down both side buttons simultaneously for 3+ seconds to turn off the device. (see FIGS. 2a,2b,3,4,5,6,7)

The system of the present invention MTASS is multi-functionally integrated, wherein each portable device includes a motion sensing (PASS-type technology) module (Module 1) (see FIG. 8). The Motion Monitoring Module has solid-state, non-position sensitive technology to sense a broad range of motion. The motion detection technology provides an input signal indicating whether the first responder is moving. The microprocessor samples the motion detection periodically to determine whether the person is physically inactive for a predetermined time period, e.g. 18 to 25 seconds, and activates a ‘pre-alarm’ mode if this time period is ever exceeded. In the ‘Pre-Alarm’ mode a progressive audible ‘Pre-Alert’ signal annunciates with flashing and is accompanied by the intermittent pulsing of four yellow LEDs. The longer the unit is in ‘Pre-Alarm’, the louder the sweeping ‘Pre-Alarm’ signal becomes, signifying that the unit is closer to the full ‘Alarm’ mode. A second alarm is activated if the inactivity period exceeds a second predetermined time limit, e.g. 35 seconds. When in full ‘Alarm’ the ‘Pre-Alarm’ is replaced by the constant rapid pulsing of four red LEDs accompanied by a loud audible ‘Alarm’ signal that rapidly varies in pitch. Status of motion detection modes (passive, pre-alarm and alarm status) are processed by a microprocessor and continually sent to the interface motherboard Interface for central processing where data packets are tagged with a 4-digit PIN-code for telemetry transmission to any monitoring mobile base station console running the MTASS software program. The motion monitored telemetry received is displayed on the MTASS software dashboard in color and alpha-coded cells: green “OK” in passive state, yellow “PA” in pre-alarm state, red “DN” for down personnel, red “MA” for manual alarm signal. The PIN-coded message is sent in 15-30 second intervals through the wireless network interface card module and wirelessly broadcasted over the Mobile Area Network. While in the passive state of monitoring (sensing) motion, the portable device's manual alarm bar, located on the upper front face of the portable device, illuminates a steady green, but can be manually put into “Alarm” mode at any time by depressing the alarm bar, providing a data signal to the microprocessor indicating an emergency situation, which places the portable device into full alarm mode, switching the manual alarm bar color from passive green to a flashing red light and sounding an audible alarm (see FIGS. 2a-b,6,8). Once placed into manual alarm the portable device processes the alarm message from the motion monitoring module through the interface motherboard Interface as a PIN-coded message to the network interface module for broadcasting as an alarm telemetry message out over the MANet. While monitoring in the automatic detection alarm mode, first responders receive alarm warnings by both visual and audible means. Visual alarm warnings are by way of high intensity red LEDs installed on the motion monitoring module illuminating the portable device's semi-translucent case during alarm modes. These LEDs strobe, flash and pulsate indicating motionless states of pre-alert and alarm modes. Audible alarm warnings are by way of dual resonating sound ports producing a 95+ dBA sound signature designed to generate multiple tones that sweep through a range of 500-4000 Hz with momentary pauses every 4 seconds, allowing the portable device to be audibly identified and tracked. The alarms can be deactivated by depressing the side reset buttons. After an alarm condition, activating the “Reset” button feature automatically messages the base station PAMS program with a green “OK” indicator signal on the associated line “recall” button, whereby advising the base station that the alarm condition of the identified wearer has been addressed. Motion alarm telemetry received by the base station software is interpreted as a flashing ‘red’ cell and alpha-code in the respective data point column and line for thermal temperature readout of the identified portable device wearer.

The MTASS Motion Monitoring Module technology also comprises motionless alarm tracking whereby any motionless or manual alarm message broadcasted from any one MTASS portable device will be received by all other active devices within the network coverage area. When a portable device enters ‘full’ motionless and manual alarm modes, multiple portable devices comprise a method of wirelessly receiving and transmitting alarm and search message radio signals between monitoring portable devices over the deployed mobile area network. Both alarm-targeted and search-targeting messages broadcast by way of a plurality of spaced spread spectrum radio frequency transceivers to permit the location of the targeted portable device to be rapidly measured for location determination to assist respondents in directional location of downed personnel. While in tracking-mode, each monitoring portable device enters into an audible-only alarm mode and the portable device display will override any current display modes to display a fluctuating signal-strength bar meter, not to be confused with the network signal bar indicator lamp, indicating distance from the alarm message signal strength—decreasing in the number of illuminated bars in weaker signaling of greater distance and increasing the number of illuminated bars for stronger signals in lesser distance, having a fully illuminated bar meter once signal target is fully acquired at immediate range of 0 meters distance. (see FIGS. 1,2a,2b,5)

The MTASS Motion Monitoring Module also comprises an integrated rugged resistance temperature detector (RTD) type sensor technology to monitor the ambient temperature of the surrounding environment to provide first responders with accurate feedback of the environmental temperature. (see FIGS. 2,3,6,9) Information regarding temperature in the ambient environment is provided by an analog signal to be converted by analog-to-digital converter into a digital signal for processing by the microprocessor. The temperature information can be processed, using algorithms to anticipate “break through” of excess thermal energy through the first responder's protective suit. When the first responder exceeds a predetermined time weighted average temperature threshold, the audible heat alarm is activated. The RTD accurately senses temperature readings up to 1,000° F. or 538° C. The integrated chip set processes collected temperature data to measure pre-determine temperature thresholds for alarm mode activation. An audible warning is activated and temperature reading flashes on the display when first responders are exposed to potentially dangerous temperatures (see FIG. 2b,5). The temperature readout can be displayed in Centigrade or Fahrenheit. A time-weighted average of heat exposure activates the audible heat alarm and flashing temperature reading on the portable device display when the environmental conditions reach predetermined levels. Temperature modes are sent to the interface motherboard interface for telemetry processing over the MANet and to display temperature readings on the system of the present invention's base station console software dashboard program (see FIGS. 2a,2b,12a,12b). Temperature alarm telemetry received by the base station software is interpreted as a flashing ‘red’ cell in the respective data point column and line for thermal temperature readout of the identified portable device wearer. The thermal temperature audible alarm can be deactivated by depressing the side “Reset” buttons. After an alarm condition, activating the “Reset” button feature automatically messages the base station PAMS program with a green “OK” indicator signal on the associated line “recall” button, whereby advising the base station that the alarm condition of the identified wearer has been addressed.

The MTASS Motion Monitoring Module technology also automatically records a data-log of all motion monitored status change events. The data-log is stored in non-volatile memory and can be retrieved via an internal fire wire port on the portable device by utilizing data-log retrieval software. Data-logged events are time and date stamped down to 1 second resolution of the last 8000 stored events. In back up to the system telemetry, the Motion Monitoring Module automatically records a data-log of all motion status change events. The data-log is stored in non-volatile memory that can be retrieved by opening the portable device to access the internal IR port on the motion monitoring module with a IR-to-USB cable and software. The required data-log events are time and date stamped down to 1 second resolution, storing up to approx. the last 8,000 events. The motion monitor module is powered by the portable device's onboard prismatic Li-Ion rechargeable battery via the motherboard interface. (See FIGS. 2a,2b,3,6,8,12a,12b)

The system of the present invention MTASS is also multi-functionally integrated, wherein each portable device includes an integrated confined space multi-gas monitoring module (Module 2). The multi-gas monitoring module sends an environmental signal alert that is representative of poison gas levels present in the air surrounding the wearer of said portable device. The multi-gas monitor module comprises a precision solid state broadband semiconductor metal oxide type gas sensor, which in alarm mode sounds a loud (95 dBA) series of audio alert tones; and a visual alert from flashing “blue” LED alarm lights to warn if any of 125 toxic/combustible gases or vapors are present at the monitoring portable device. Alarms are transmitted as an alarm signal to the motion sensing modules' CPU and sending information to the portable device interface motherboard interface's micro controller unit for processing and sent out through the portable device's configured wireless network interface card module for broadcast over the MANet. Sensing status is sent through the system of the present invention for telemetry processing over the MANet to display status on the system of the present invention's base station console software dashboard program, which is interpreted by the software on the dashboard as a ‘green’ cell indicator for neutral or passive gas status and blinking ‘blue’ cell indicator for a ‘gas present’ alarm. Incident command can send an ‘EVAC’ signal from the base station software to the gas alarming portable device to recall or warn the wearer if no reset signal is received in a timely manner. The gas alarm can be deactivated by depressing the side “Reset” buttons to turn off the alarm. After an alarm condition, activating the “Reset” button feature automatically messages the base station PAMS program with a green “OK” indicator signal on the associated line “recall” button, whereby advising the base station that the alarm condition of the identified wearer has been addressed. Once the gas sensor is cleared of gas detection, the telemetry signal reverts back to a passive state of signal telemetry to the base station software program that interprets a ‘green’ illuminated cell indicator of a return to neutral or passive status. The multi-gas monitor module is powered by the portable device's onboard prismatic Li-Ion rechargeable battery via the motherboard interface. (see FIGS. 2a,2b,3,6,9,12a,12b)

The system of the present invention MTASS is also multi-functionally integrated, wherein each portable device includes a multifunctional wireless personal area network (WPAN) module (Module 3) and an assigned Wireless Biotelemetry Monitoring Transmitter that serves as a peripheral device part of the system of the present invention. The WPAN module comprises 802.15.4 or Bluetooth wireless technology with programmable firmware via an external Infra0Red (IR) port to computer USB port connectivity. The 802.15.4 provides communication with not only the MTASS Wireless Body Area Network (WBAN) Biotelemetry Monitoring Transmitter for heart rate monitoring (HRM) and dermal temperature monitoring (DTM), but also with OEM wireless peripherals—such as wireless air tank transmitters, streaming video from wireless transmitting thermal imagers and helmet cameras. The system of the present invention's WBAN Biotelemetry Peripheral Transmitter device and applicable OEM peripheral devices having a signal emitter generating device, generate a unique identification signal that is characteristic of the transmitter. The peripheral transmitter's coded identification signal is programmed into the MTASS WPAN module where it is received and tested. If the identification signal matches an identification comparison signal stored in the monitoring portable device's WPAN programmable firmware, data is accepted and processed through the motherboard interface's microcontroller unit. WPAN telemetry data sent to the motherboard interface for telemetry processing is transmitted over the MANet to display readings on the system of the present invention MTASS's base station console software dashboard program. The WPAN module is powered by the portable device's onboard prismatic Li-ion rechargeable battery via its motherboard interface. (see FIGS. 1,2a,2b,10a,10b,12a,12b)

For biotelemetry monitoring, the system of the present invention's base station software includes a dashboard readout of numeric data for HRM beats per minute (bpm) and dermal (skin) temperature. The software program also provides for a biotelemetric alarm program whereby biotelemetry received from a given monitoring portable device(s) is processed against a time-weighted measure of pre-determine heart rate beats-per-minute (bpm) and dermal temperature thresholds for alarm mode activation for both excessive high heart rate and dermal temperature time readings. Both heart rate monitoring (HRM) & dermal temperature monitoring (DTM) biotelemetry are displayed as numeric values in the respective line-column cells of the MTASS software control system dashboard. Any biotelemetric alarms that are determined by the MTASS software program appear as a flashing ‘red’ illuminated cell of the numeric HRM and DTM values. Incident command can recall any biotelemetric alarming personnel by sending an “EVAC” recall message signal to the identified monitoring portable device. (See FIGS. 2b,10b,12a)

For SCBA monitoring, the system of the present invention's WPAN module microprocessor (MCU) processes the peripheral air pressure transmitter data received by the integrated OEM 802.15.4 ECI controller from a wireless air tank transmitter (see FIG. 10a). The received air tank pressure data is determined and this pressure value is used to calculate the air consumption rate to determine the remaining air time. The remaining air time (RAT) is a computed projection of the time remaining until the tank pressure reading is zero. Since a direct measure of consumption rate is not available due to the intermittent nature of breathing and to the digital nature of the measured pressure, the rate of consumption is computed from the change of air pressure divided by the time for that change. The most current value of air pressure received is used to comparatively calculate the change in tank pressure from the previously received reading. For as long as the resulting calculations of air pressure readings register over 20 percent of the original air tank volume, the processing proceeds. If the current air pressure registers less than 25 percent of the original air tank volume, a blinking low air pressure message (“LAP”) is displayed on the system of the present invention's LED or LCD display and an audible alarm is activated to alert the user to the low tank pressure (see FIG. 2b,5). The audible alarm can be deactivated by depressing the side “Reset” buttons. After an alarm condition, activating the “Reset” button feature automatically messages the base station PAMS program with a green “OK” indicator signal on the associated line “recall” button, whereby advising the base station that the alarm condition of the identified wearer has been addressed. Both air pressure and the overriding low air pressure warning message modes are processed through the system of the present invention for telemetry processing over the MANet to display temperature readings on the system of the present invention's software control system dashboard program. Air tank pressure is displayed in remaining pounds per square inch (PSI), air tank time remaining is displayed in minutes and seconds and a non-active SCBA system displays as “OFF” for air PSI and time. (see FIGS. 2a,2b,5,12a,12b)

For personnel locator tracking, the system of the present invention MTASS's WPAN module also comprises components with positioning and communication systems to support real-time accountability tracking of and communications with emergency response personnel position and time information via an integrated Global Positioning System (GPS) chip set. The WPAN module's GPS tracker chip set provides longitudinal and latitudinal readings to the MTASS mobile and central command base station console software. The MTASS portable device GPS also provides a satellite monitored locator signal for the MTASS base station command console software to wirelessly connect to the internet via mesh network linkage to access mapping topologies for tracking the location of monitoring MTASS portable devices. (see FIGS. 2a,2b,10a,12a)

The system of the present invention is also multi-functionally integrated, wherein each portable device is equipped with a modular type Wireless Network Interface Card (WNIC) (Module 4), which is network configurable to swap out and reconfigure to function in either an 802.11 or 3G-cellular wireless network application infrastructures (see FIGS. 11,14a). The portable device Interface Motherboard interface's programmable EEPROM firmware design allows for bios configuration of the type of wireless network card to be used. The WNIC module is powered from the portable device's onboard prismatic Li-Ion rechargeable battery via it's motherboard interface (see FIGS. 2a,2b,4,6).

The system of the present invention MTASS is also multi-functionally integrated, wherein each MTASS portable device has a protective translucent silicone grip band integrated around the MTASS portable device PPSU case siding with open front and back for optimum operational and service functionality. The translucent silicone grip band improves physical handling of the portable device, while also further insulating and protecting from severe shock impact, vibration and heat exposure, without inhibiting LED case illumination. (see FIG. 3)

The system of the present invention is also multi-functionally integrated, wherein each portable device includes a wire clip fitted onto the external surface of the rear panel, configured to securely hold the portable device to a SCBA or rescue harness, or clip to turn-out gear, utility belts, lowering ropes, etc.

The system of the present invention's Personnel Accountability Management System (PAMS) is a software control system that provides network area accountability and situational awareness overview and individual profiling of the twelve telemetry parameters received over a wireless network from any monitoring portable devices. The software control system comprises a graphical user interface (GUI) dashboard-design software program for command and control communications from both onsite and central applications to monitor and log the telemetry broadcasted over a wireless network from each monitoring system of the present invention portable device deployed within the network. Depending upon the wireless network capability, a mobile command base station can monitor up to 55 monitoring portable devices of first responders at one time. When networked to a Wireless Metropolitan or Wide Area Mesh Network or SatCom link, the system of the present invention's PAMS software program has Internet linkage buttons to query local area weather conditions, global positioning system (GPS) mapping of signaling portable devices and other programmable internet link-to-information features. (see FIGS. 2b,12a, 12b, 13)

The system of the present invention MTASS's PAMS software program allows an emergency agency to program unique PIN codes of each portable device to be interpreted to display customized identifications in the Personnel field of the dashboard screen (e.g. PIN-code “0123”=Personnel ID “Sta-17, Eng-23, Seat-03, John Doe”). Upon receiving PIN-coded telemetry transmissions from monitoring portable devices, the PAMS software program interprets PIN-codes and subsequently stores and displays the received information, populating the dashboard data point parameters. The data points include the accountability and situational awareness parameters of PIN number, Personnel ID, activation status, assignment, SCBA status, motion status, battery status, ambient thermal temp, biotelemetry (Heart Rate/Dermal Temp), gas detection status, GPS status, of any monitoring portable device within the deployed mobile area network (MANet). When any line item category of accountability & situational awareness parameter goes into an alarm mode, the intersecting line-column cell of the identified portable device will flash in color to indicate am alarm status to alert command to view the dashboard screen, query the line item and even message the alarming portable device wearer. (see FIGS. 2b,12a, 12b, 13)

For personnel locator tracking, the system of the present invention MTASS's PAMS software program receives and displays monitored GPS longitude and latitude readings of deployed MTASS portable devices within the incident area. The MTASS PAMS “Map GPS Locations” dashboard button provides incident command with linkage to GPS tracking & satellite topology mapping of deployed assets as targeted signals within the MANet. The GPS topology mapping feature proves most useful in outdoor geographically dispersed incident deployments, as for application in wild-land fires, natural disaster zones, search and rescues or any other wide area disbursement scenarios (see FIG. 13). The PAMS “RF Tracking” dashboard button provides incident command with the network administrative feature to calculate/triangulate approximate location of selected personnel, as with alarm reading MTASS portable devices, from radio frequency signal measurements received from MANet Access Points which are shown on a plotting graph (see FIG. 13). In the event of alarm indications of either flanking fires, structural collapse, flash-flood, avalanche awareness, etc., the PAMS software program provides incident command with individual and entire personnel recall ability. From a mobile command base station server, command can transmit an “EVACUATION” signal to recall individuals or all personnel equipped with monitoring MTASS portable devices within the MANet. By selecting either individual line item recall buttons or depressing the “ALL” button to globally message all monitoring portable devices for recall, a yellow “sent” indicator displays on the software button and the broadcasted recall message activates a steady tone and flashes “EVAC” on the display of the targeted monitoring portable device(s). Alerted first responder personnel can then acknowledge the command and quite the alarm by pushing the side reset buttons to quiet the alert signal and ping back a green “OK” message that appears on the selected “recall” key(s) of the mobile command base station dashboard software program and, if mesh networked, onto central command. (see FIGS. 2a-b,12a)

If an alarm results from a time violation from one of the technology timers, or from error caused by depression of alarm switch, the wearer can suitably cancel any alarm signal by depressing the side reset buttons. After an alarm condition, activating the “Reset” button feature automatically messages the base station PAMS program with an “OK” indicator signal on the associated line “recall” button, whereby advising the base station that the alarm condition of the identified wearer has been addressed. Thus, false alarm conditions resulting in unnecessary initiation of rescue operations are minimized, resulting in more diligent attention to actual emergency situations. (see FIG. 2a-b,12a)

### BRIEF DESCRIPTION OF THE DRAWINGS

The accompanying drawings, which are incorporated in, and constitute a part of, this specification illustrate several embodiments of the invention and together with the description, serve to explain the objects, advantages, and principles of the invention.

FIG. 1 The system of the present inventions' Operational Concept.

FIG. 2a The system of the present inventions' portable device technical functionality block diagram.

FIG. 2bThe system of the present inventions' flow chart block diagram.

FIG. 3 An illustration of the physical embodiment of the system of the present invention's front, right-side and top view casing.

FIG. 4 An illustration of the physical embodiment of the system of the present invention's rear quarter pull-away assembly view of the casing and internal parts.

FIG. 5 System of the present invention's Digital LED or LCD Display possible functions diagram.

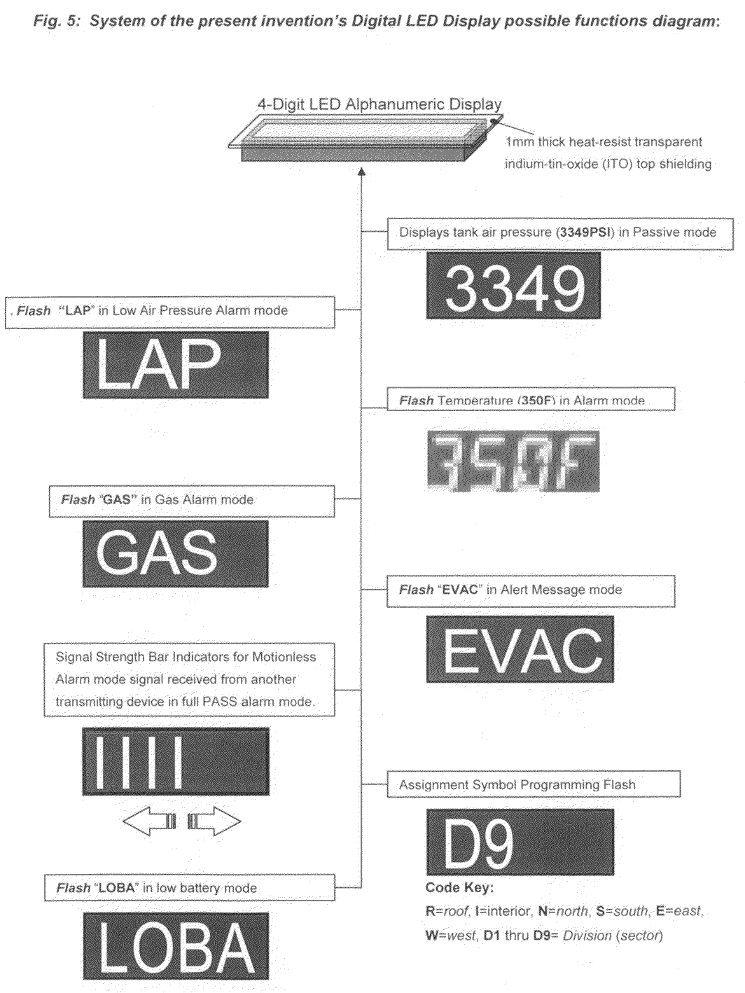

FIG. 6 An illustration of the physical embodiment of the system of the present invention's internal device fully assembled configuration.

FIG. 7 An illustration of the physical embodiment of the system of the present invention's Mother Board Interface.

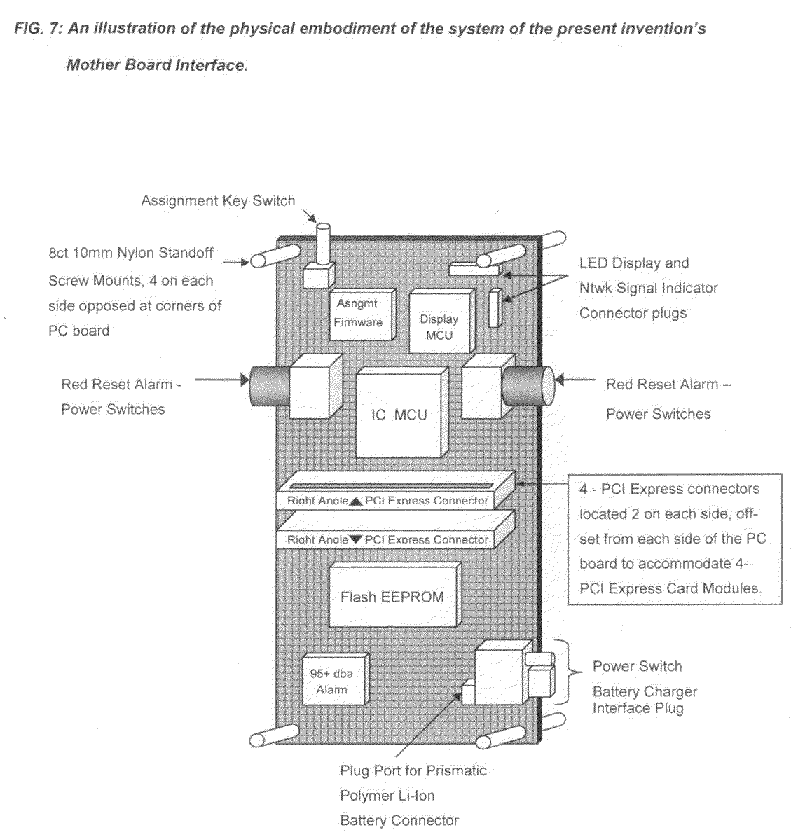

FIG. 8 An illustration of the physical embodiment of the system of the present invention's Motion Monitoring Module (Module #1).

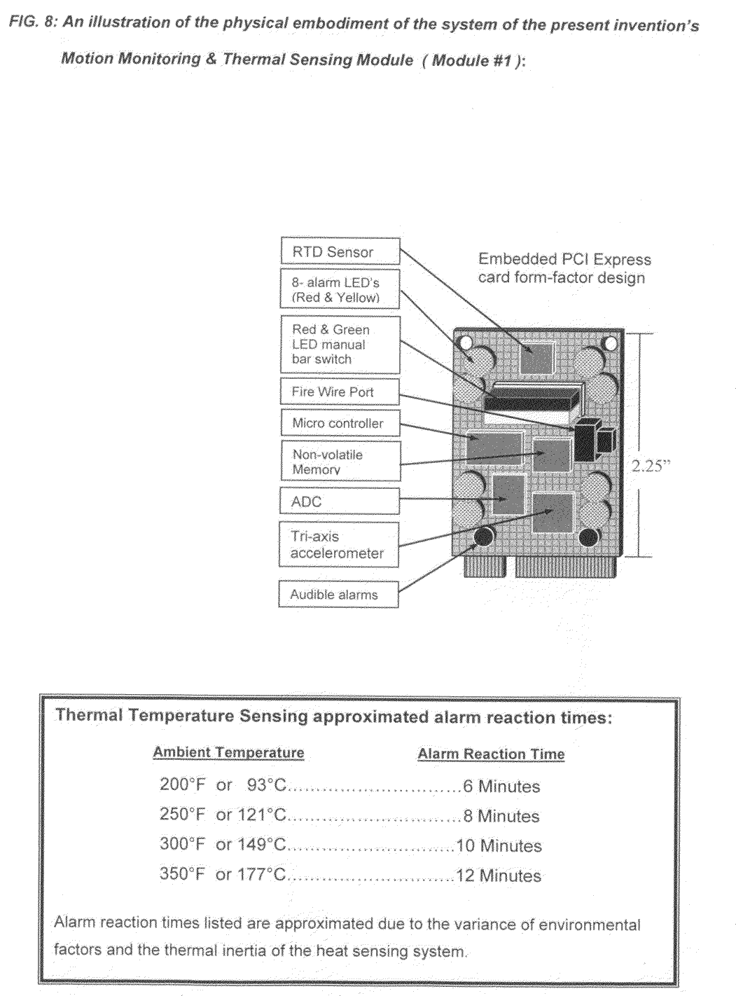

FIG. 9 An illustration of the physical embodiment of the system of the present invention's Gas Alarm Monitoring Module (Module #2).

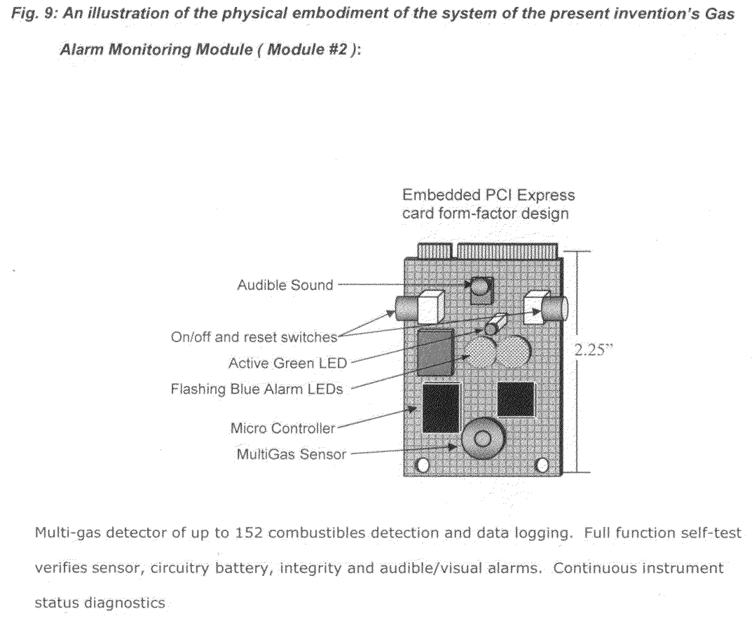

FIG. 10a An illustration of the physical embodiment of the system of the present invention's Wireless Personal Area Network (WPAN) Module (Module #3) and its Wireless Biotelemetry Monitoring Transmitter Peripheral Device.

FIG. 10b An illustration of the physical embodiment of the system of the present invention's Wireless Biotelemetry Monitoring Transmitter Peripheral Device

FIG. 11 An illustration of the system of the present invention's Wireless Network Interface Card (Module #4).

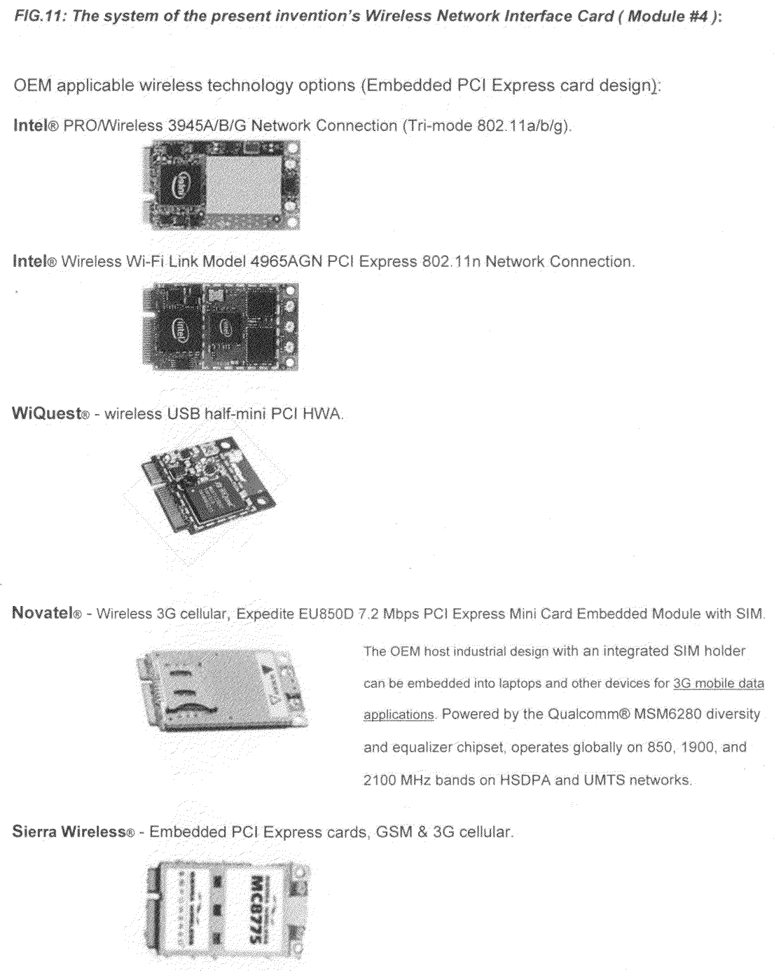

FIG. 12a An illustration of the Personnel Accountability Management Software (PAMS) Program's “Dashboard” design for the system of the present invention's mobile area network base station console monitoring.

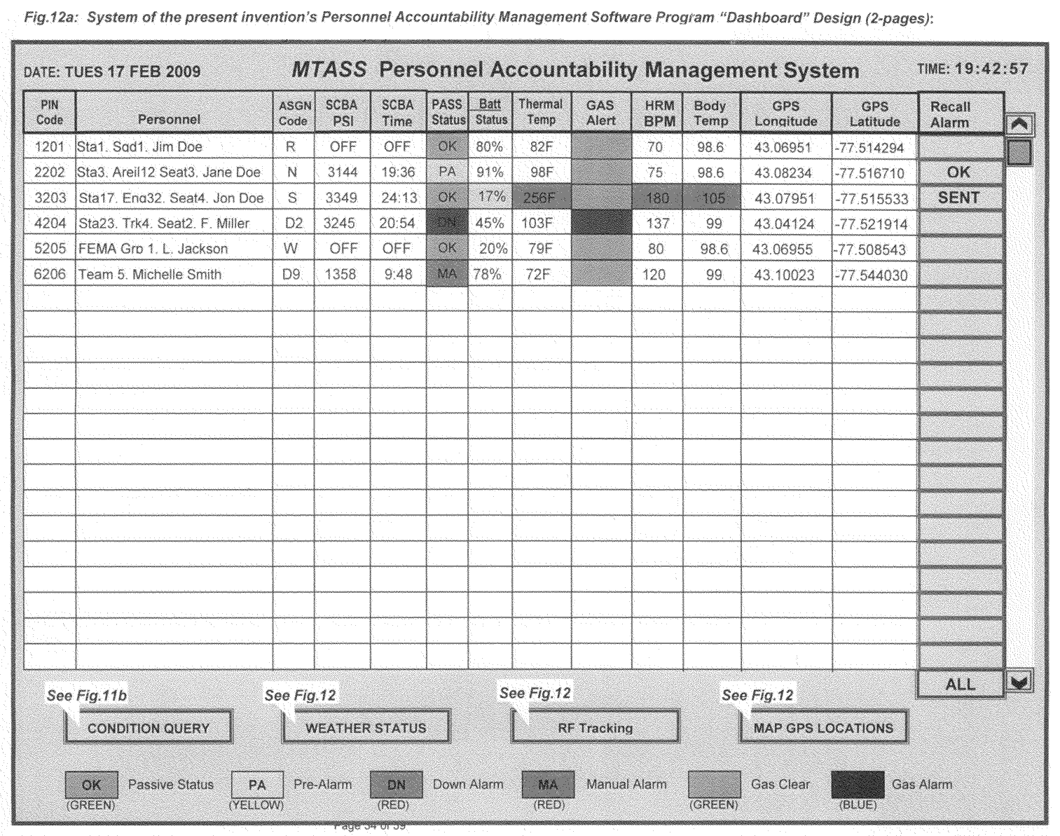

FIG. 12b An illustration of the system of the present invention MTASS Personnel Accountability Management Software (PAMS) program's individual “Condition Query” screen design.

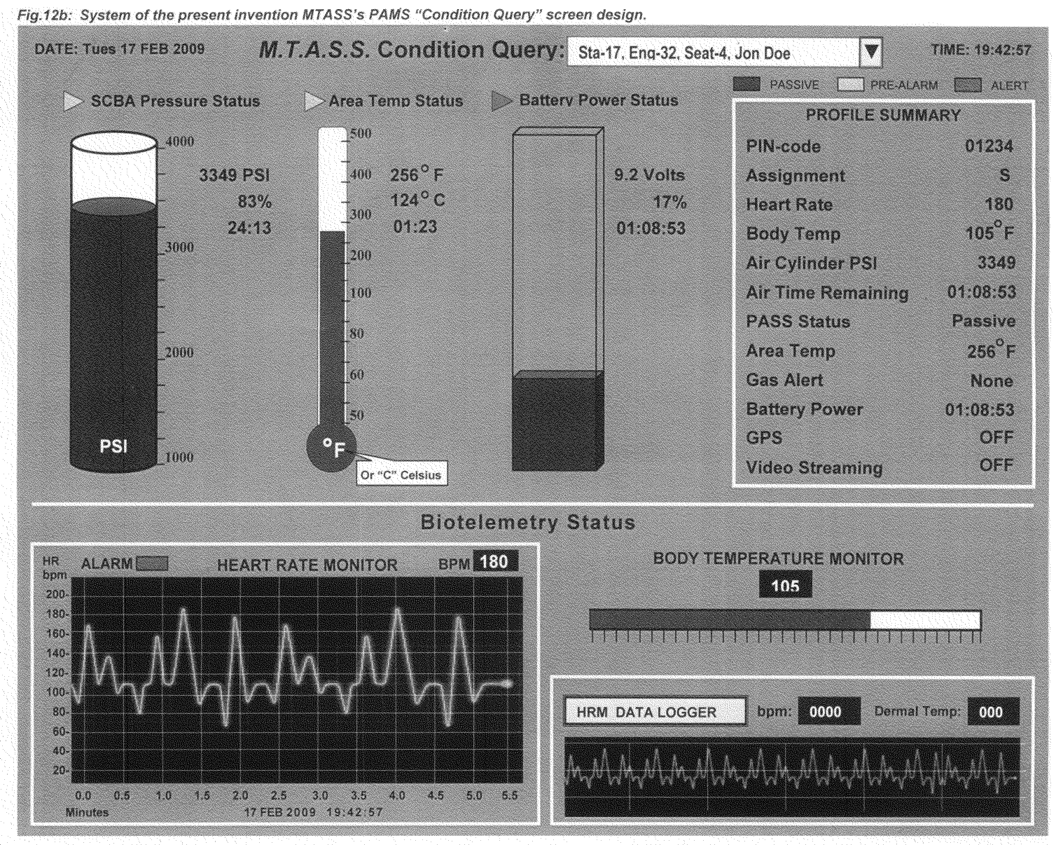

FIG. 13 The system of the present invention's Personnel Accountability Mgmt Software screen link concepts.

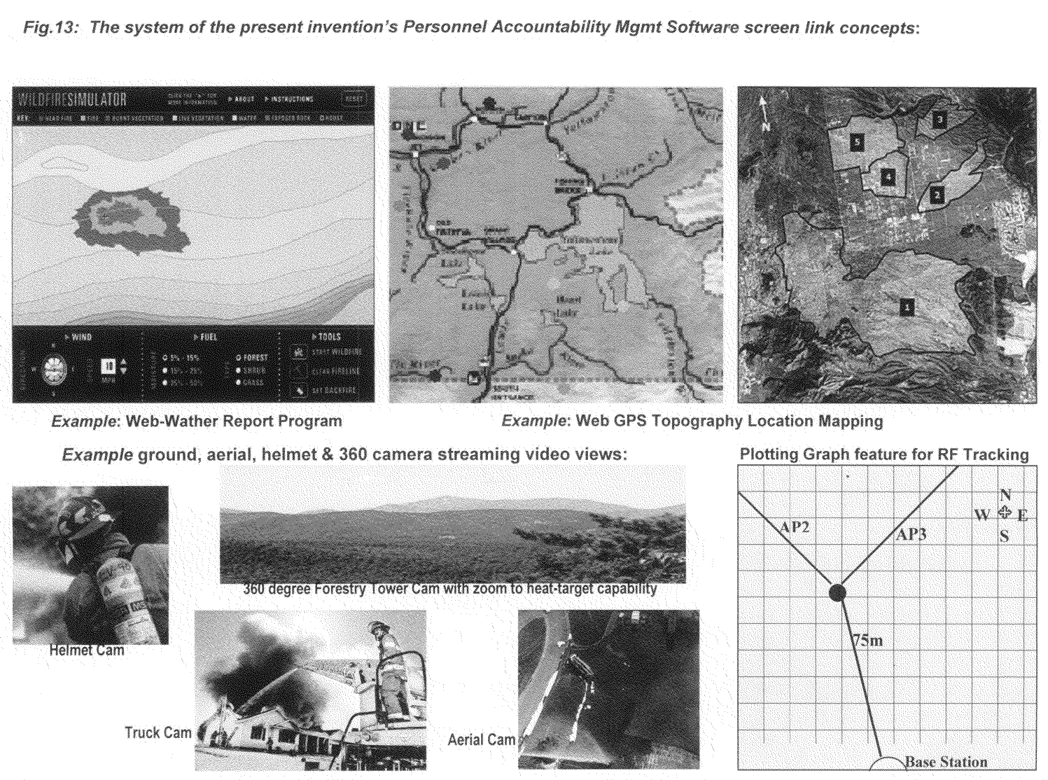

FIG. 14a The system of the present inventions' wireless Mobile Area Network (MANet) Topology 1.

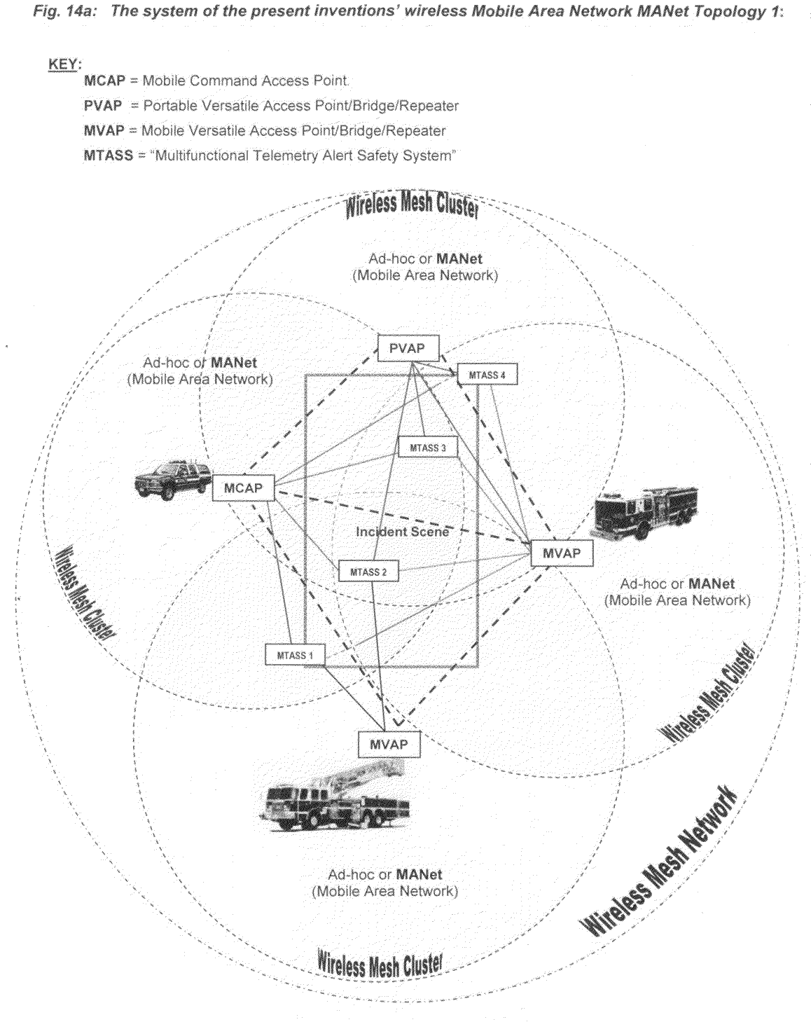

FIG. 14b The system of the present inventions' wireless Mobile Area Network (MANet) Topology 2.

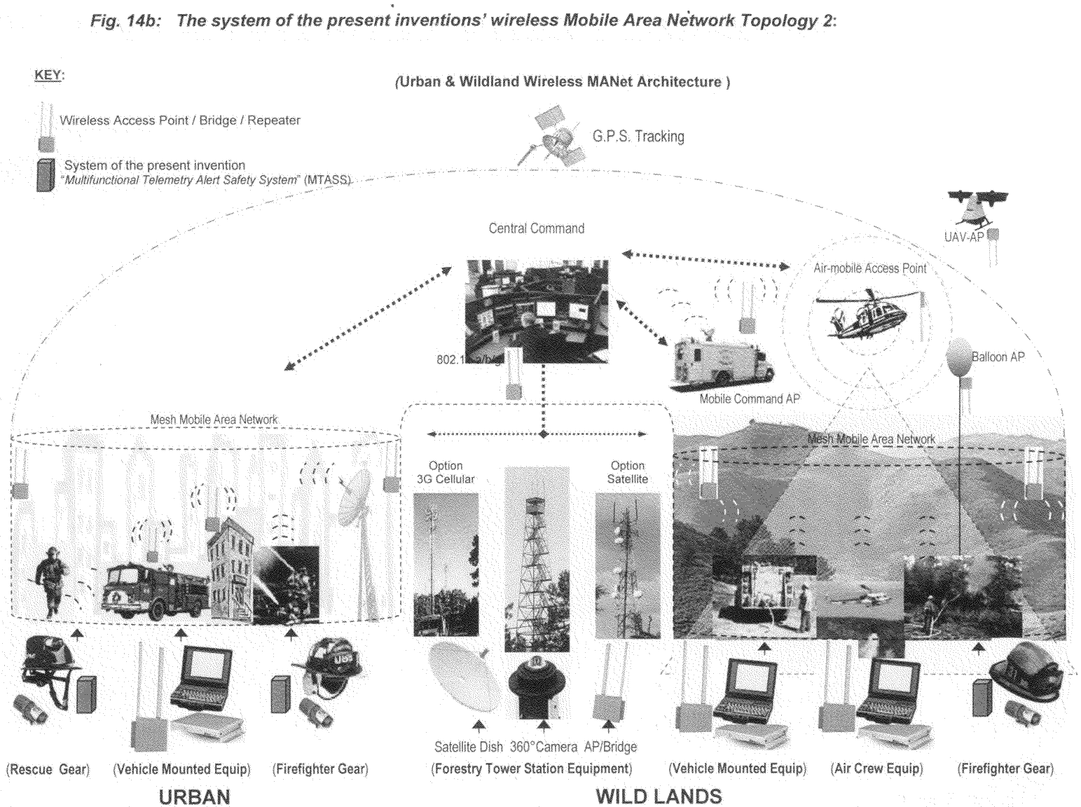

FIG. 15 An illustration of the system of the present inventions' accessory Charger Docking Station Rack & Case

The embodiments of the invention in which an exclusive property or privilege is claimed are defined as follows:

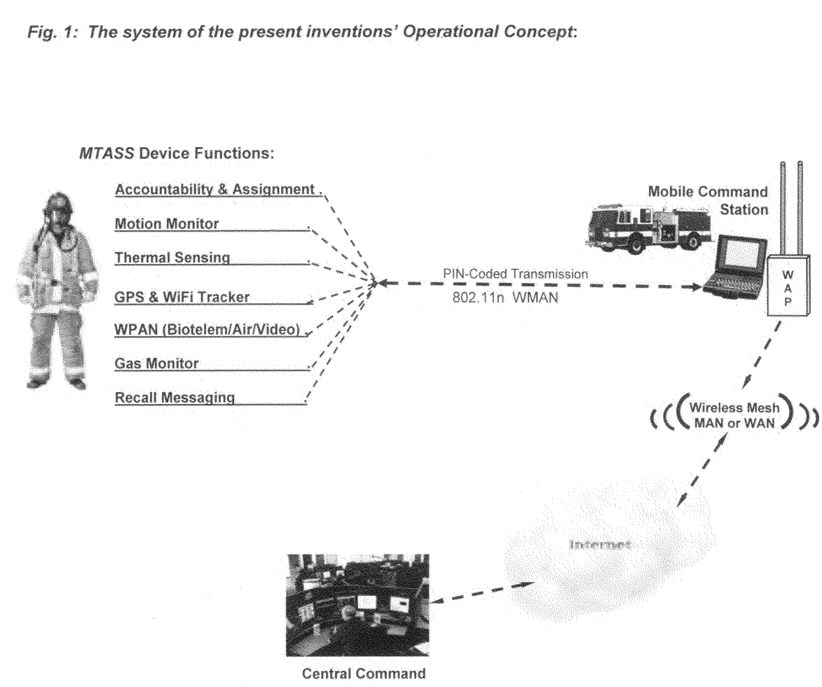

1. The system of the present invention MTASS is unique and advantages to first responders of emergency services due to its twelve integrated wireless network adaptive telemetry technology functions: 1.) personnel accountability identification, 2.) assignment coding, 3.) heart rate biotelemetry monitoring, 4.) dermal temperature biotelemetry monitoring, 5.) SCBA air time & cylinder pressure monitoring, 6.) multi-gas alert sensing, 7.) motionless alert monitoring, 8.) ambient temperature monitoring, 9.) GPS tracking, 10.) RF alarm tracking, 11.) streaming video transmission capability, 12.) “Evacuation” recall-signal transceiver, all integrated into one singular rugged device, supported by remote software, OEM peripherals and network equipment, providing optimum operational safety, improved work efficiency at an increased plurality of desired first responder accountability and situational awareness monitoring during emergency operations. (See FIGS. 1,2a/b,12a/b)

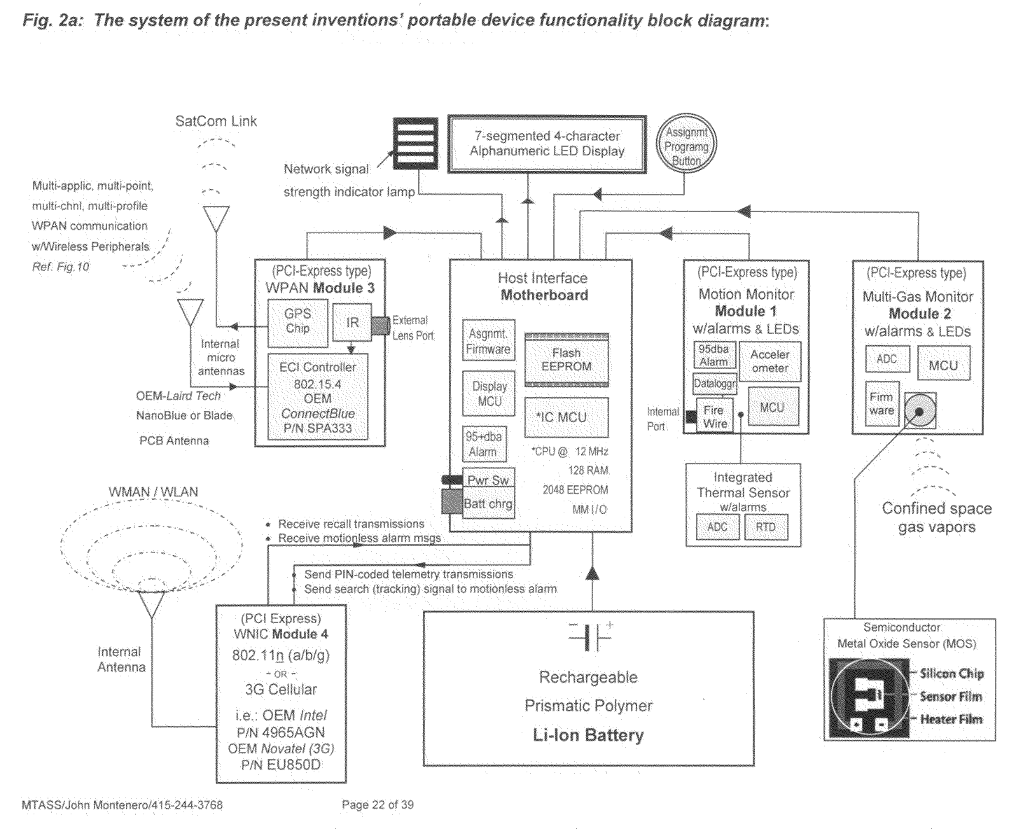

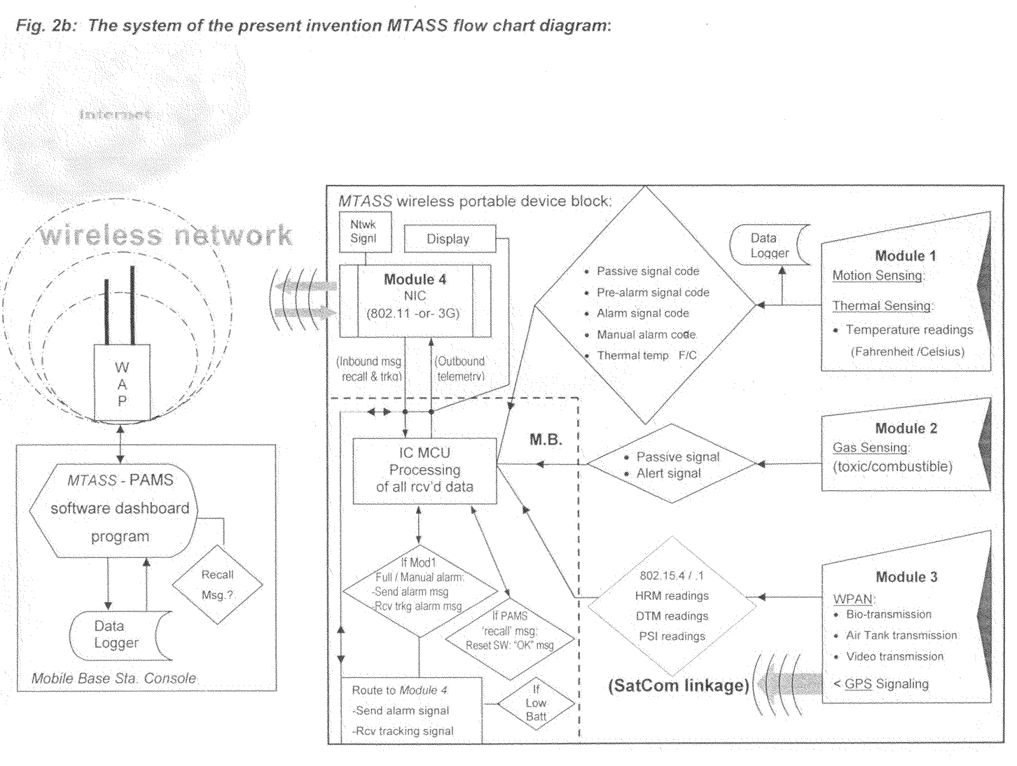

2. The system of the present invention MTASS is also unique by its modularity in form factor design of its multi-technology integration that achieves the following: modular and customizable flexibility in wireless network infrastructure adaptation, streamlined form factor design for greater user efficiency and handling, consolidated integration for end user monitoring convenience, modularity for reduced equipment maintenance and repair time and costs. (see FIGS. 2a-b,4,6)

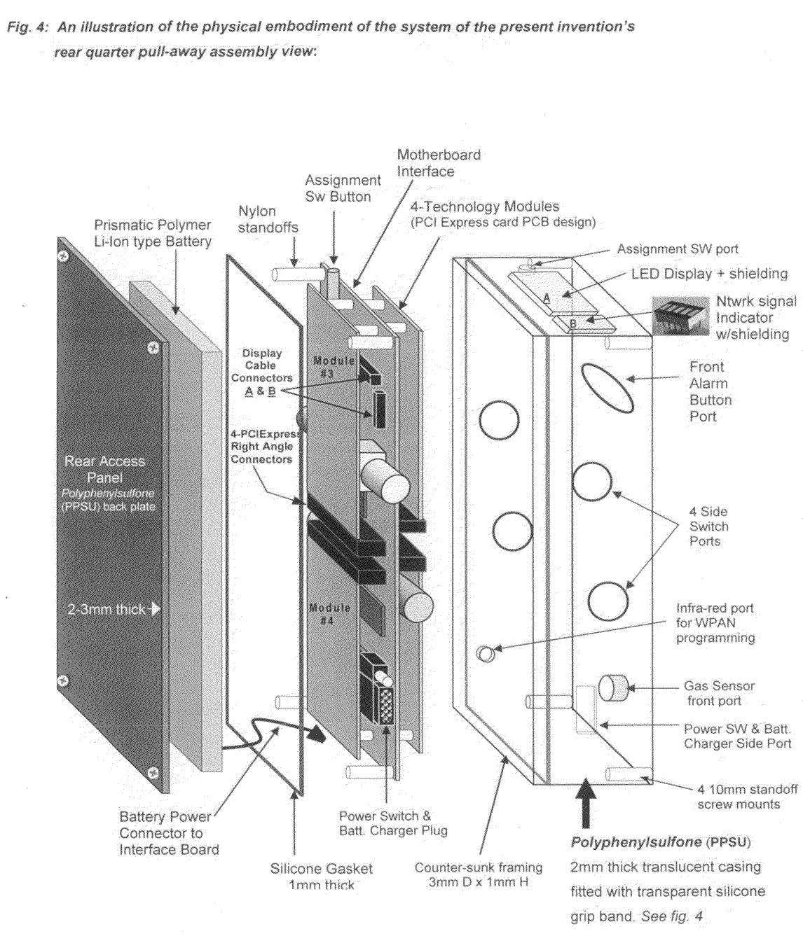

3. The network adaptation of claim 2, wherein the system of the present invention MTASS is also unique in its reconfigurable wireless modular adaptability to a variety of OEM 802.11 radio and 3G-cellular wireless mesh network infrastructures by way of the system of the present invention MTASS's modular and reprogrammable technology. Modularity in form factor design of the network interface card configuration and the onboard custom programmable bios firmware provides for customization of wireless network interfacing to adapt to a variety of mesh network applications. (see FIGS. 4,14a-b)

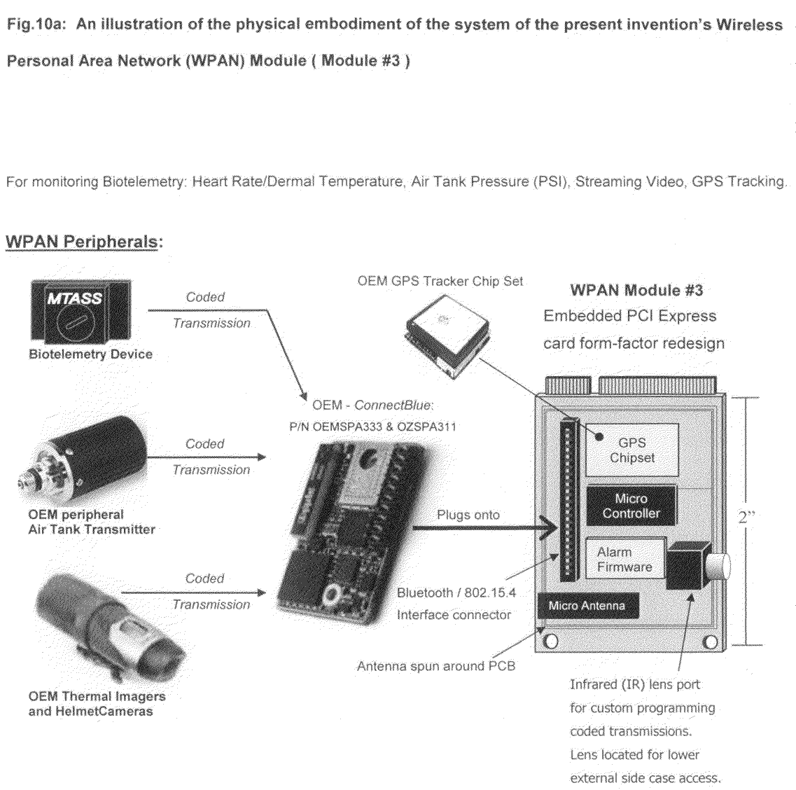

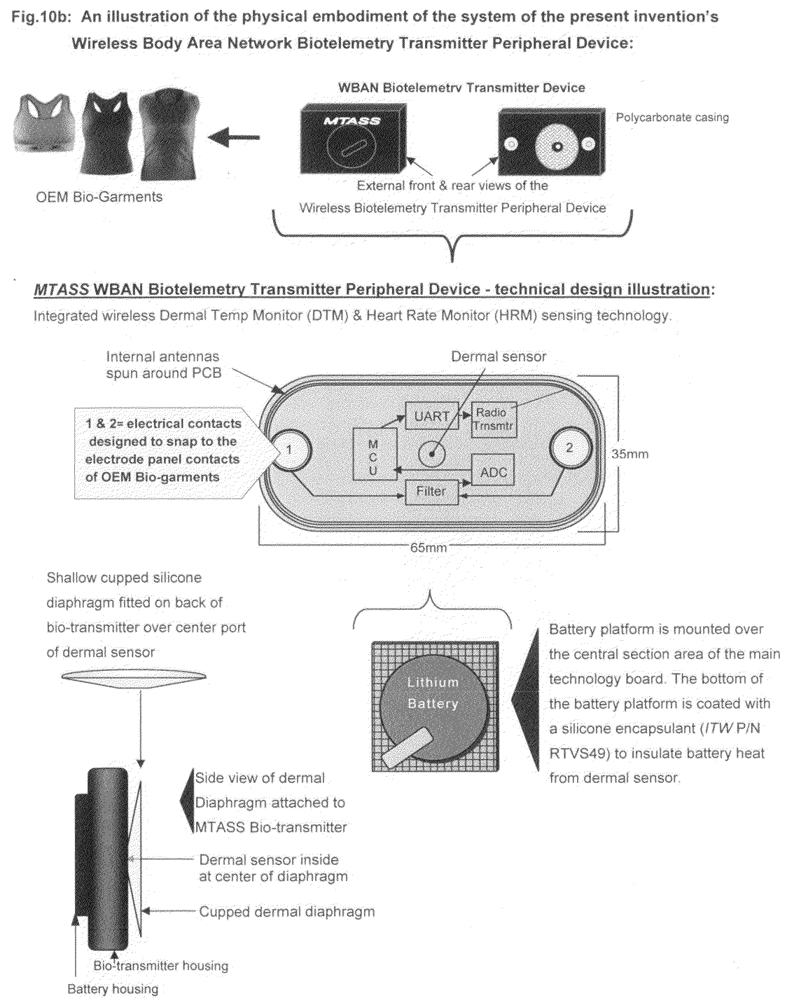

4. The system of the present invention MTASS is also unique in its integrated wireless personal area network (WPAN) module technology as being programmable to adaptively integrate with various OEM wireless body area network (WBAN) or wireless 802.15.4 (Bluetooth) peripherals. WBAN peripherals are dedicated by assignment to each portable device by way of customizable coded transmissions that prevent “cross-talk” between other peripherals of other nearby portable devices. Each portable device WPAN module's firmware chip set is reprogrammable by way of portable device Infra Red (IR) port to computer USB port cable connectivity and software. Certain wireless peripheral devices have a transmitter with a signal emitter generating devices which generates an identification signal that is characteristic of the transmitter. This unique numeric ID of a peripheral's transmitter is programmed into the the system of the present invention's WPAN module's bios firmware chip set. The data signal and identification signal are received and tested by a receiver in the portable device's WPAN module. If the identification signal matches (recognized) an identification comparison signal stored in the monitoring portable device via its WPAN programmable firmware, data is accepted and processed through the interface boards controller unit and sent through the wireless network interface module over the local network to base stations that then use the signal to monitor status and locate/track the signal emitter. Unlike other systems, the system of the present invention's flexible bios firmware technology architecture allows for the system of the present invention's adaptability to any SCBA having a two-stage air system interfaced with an OEM air tank transmitter (see FIG. 10a/b).

5. The biotelemetry of claim 1, wherein the system of the present invention MTASS is also unique in its addition of a wireless biotelemetry peripheral transmitter device. This peripheral device technology comprises the integration of both a heart rate monitor (HRM) and a dermal (skin) temperature monitor (DTM) into a single wireless transmitter unit as a peripheral device part of the system of the present invention. The biotelemetry unit wirelessly broadcasts telemetry of measured heart rate and dermal (skin) temperature as a coded transmission from the peripheral unit to the associated portable device's WPAN module for processing to the motherboard interface of the portable device and then broadcasted over a MANet to command base station(s) running the system of the present invention's dashboard software program to accommodate received telemetry data. The unique code to each wireless biotelemetry peripheral device is programmed into its associated system of the present invention portable device's WPAN programmable firmware, as described in claim 4. The system of the present invention's wireless biotelemetry peripheral transmitter device is designed to interface with OEM cardio-shirt product line technologies that have an electrode panel designed into the garment. (see FIGS. 10a-b,12a-b)

6. The system of the present invention MTASS is also unique in its application of a Polyphenylsulfone (PPSU) type casing with a transparent indium-tin-oxide (ITO) heat-resist top shielding over the display port areas, combining greater temperature and impact durability, lighter weight, enhanced strength and customized color translucency as compared to other polymer plastics. The portable device PPSU casing protects the internal technology from exposure to shock, heat, moisture, chemical and other hostile agent exposures.

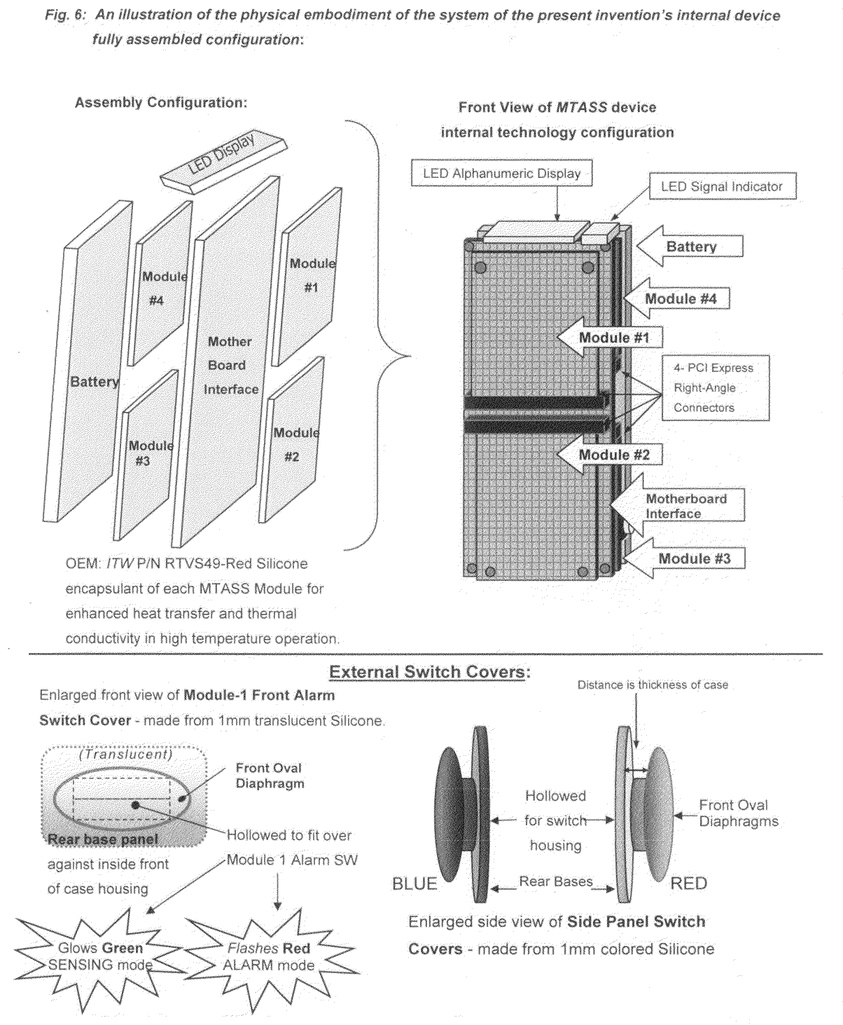

7. The system of the present invention MTASS is also unique in its RTV Silicone encapsulation of the device's electronic technology circuit boards/modules (see FIG. 6). The RTV Silicone encapsulation of the portable device's circuit boards/modules provides for enhanced heat transfer and thermal conductivity in high temperature environment operation.

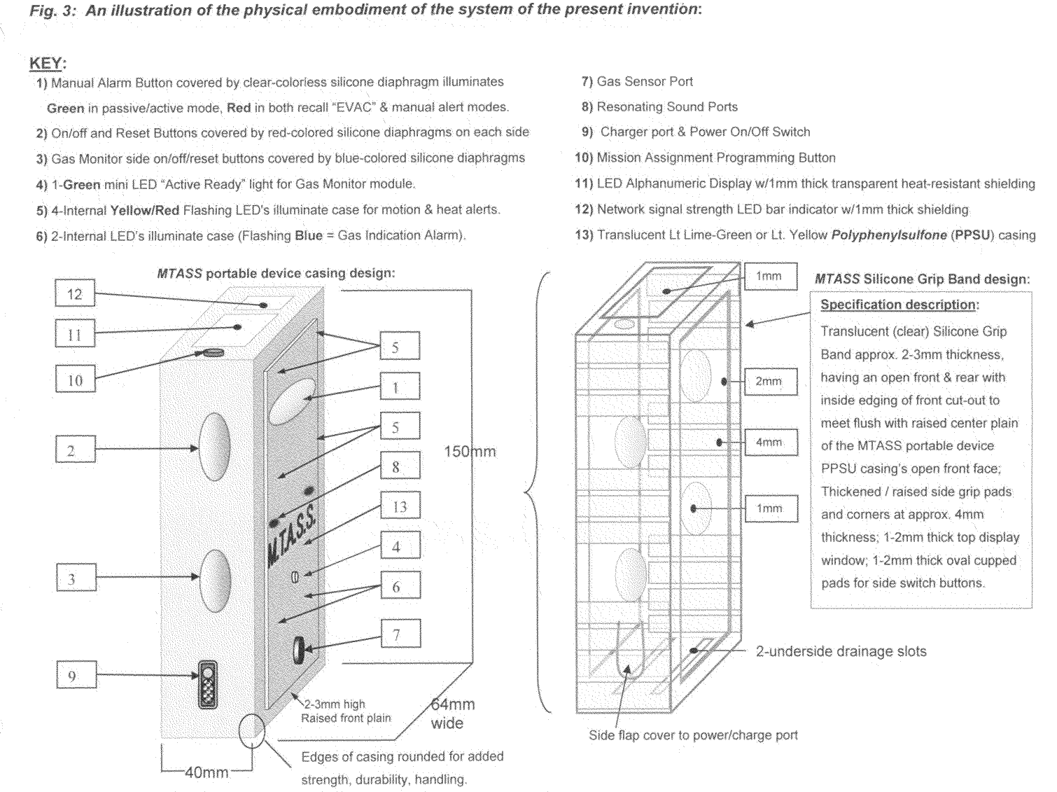

8. The system of the present invention MTASS is also unique in its application of a shock and heat protective silicone grip band custom-fitted around the siding of the portable device. (see FIG. 3)

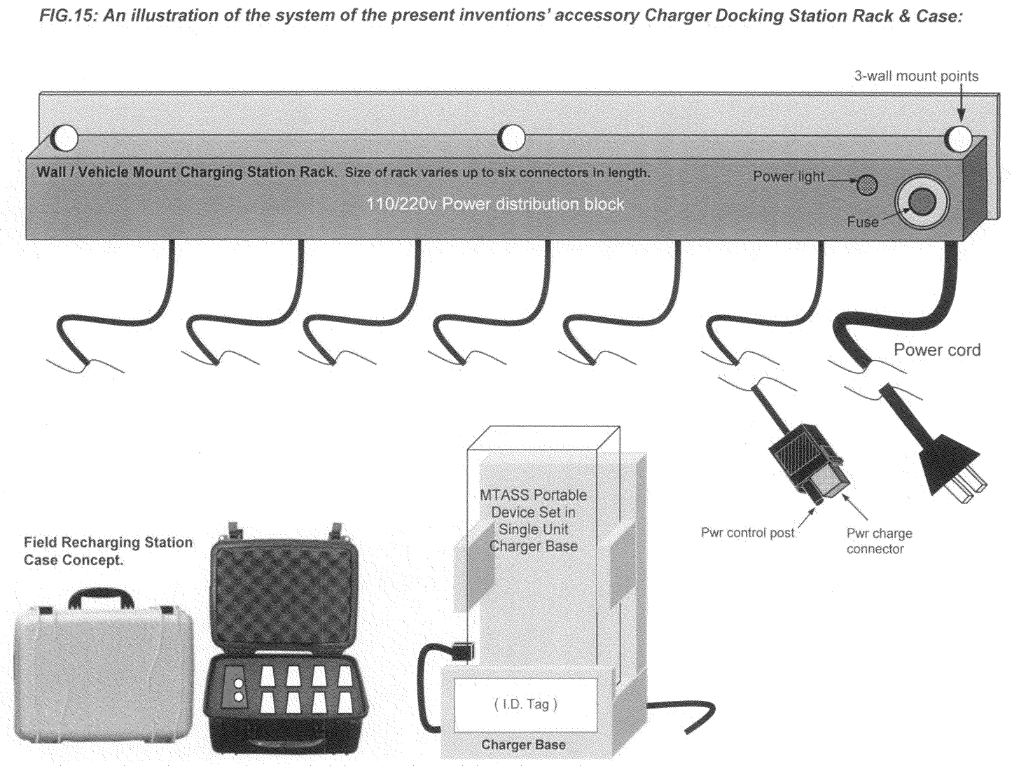

9. The system of the present invention MTASS is also unique in its application of a rechargeable internal prismatic Li-Ion battery design (see FIGS. 2,4,6,15) and an automatic on/off power function integrated with the battery charger function, wherein each MTASS portable device is automatically powered off whenever the battery charger plug is inserted into an MTASS portable device and automatically powered on whenever the charger plug is removed. From the front view of the MTASS portable device, the power/charger port is located on the lower left hand side and protected by a port access flap of the integrated silicone grip band (see FIG. 3). The power/charger control plug makes end-to-end contact with the power pressure switch post to activate the power function of the MTASS portable device and a battery charger connector for interfacing with the charging port of the MTASS portable device. The integrated auto-power/charger port mates up with either the MTASS system fixed wall or vehicle-mounted charging station, or portable charger case station accessories (FIG. 15).
It should be understood that while we have described certain embodiments of the invention, we do not intend to be restricted thereto, but rather intend to cover all variations, improvements and modifications which come within the spirit of the invention, which is limited only by the claims that are appended hereto and by the breadth of interpretation allowed by law.
